(19) United States
(12) Patent Application Publication
(10) Pub. No.: US 2013/0037995 A1
(43) Pub. Date: Feb. 14, 2013

(54) Mold Core for Molding and Controlling the Temperature of a Hollow Structure

(71) Applicant: André Alexander Stieglitz, Bremen (DE)

(72) Inventor: André Alexander Stieglitz, Bremen (DE)

(21) Appl. No.: 13/578,068

(22) PCT Filed: Feb. 7, 2011
(86) PCT No.: PCT/DE2011/000114

§ 371 Date: Sep. 19, 2012

(30) Foreign Application Priority Data
Feb. 9, 2010 (DE) 10 2010 007 270.2

(51) Int. Cl. B29C 33/52; B29C 35/02

(52) U.S. Cl. 264/404; 249/111; 264/219; 427/125

(57) ABSTRACT

A mold core for molding and controlling the temperature of a hollow structure comprises an electrically non-conducting or only slightly conducting inner area and an electrically conducting outer area and two electrical contacts accessible from outside for applying a voltage, wherein the thickness of the outer area is constant or is specifically varied. A method for producing a mold core comprises molding a first body to form an inner electrically non-conducting or only slightly conducting area of the mold core and applying molding material to the first body to form an outer electrically conducting area of the mold core and attaching two electrical contacts accessible from outside for applying a voltage, wherein the thickness of the outer area is constant or specifically varied.

### BACKGROUND

The present invention relates to a mold core for molding and controlling the temperature of a hollow structure and to a method for producing such a mold core.

Mold cores are normally used to produce hollow structures, for example fiber composite structures. A distinction can be made between single-use cores and repeat-use cores, whereby repeat-use cores can be reused while single-use cores are washed out of the finished hollow structure and thereby destroyed after a single use. This can be meaningful if due to the geometry of the hollow structure to be produced there is no possibility of the usual removal of the mold core. Single-use cores can be removed, i.e. rinsed out, chemically, thermally or by means of a liquid and usually consist of a mold core base material and a binding agent.

German document DE 195 34 836 C2 discloses a water-soluble mold core for injection molding of plastic parts. Enrichment of the mold core material with metal powder particles and other materials is provided in order to improve the processability of the mold core material. Also disclosed is the coating of the mold core with a covering layer which is maximum 0.3 mm thick and has, inter alia, graphite as a constituent part. A further layer is intended to improve the surface quality of the mold core. Thus the, disclosed mold core has the disadvantage, however, that it has no means for heating the hollow structure to be molded. The hardening of the hollow structure thus takes place relatively slowly and lacks any means for guaranteeing even hardening.

European document EP 1 323 686 B1 discloses a method for producing mold cores which in turn are to be used to form hollow bodies comprising fiber reinforced ceramic materials. Through electrical resistance heating the mold core can be heated. In this connection additional electrically conducting substances are homogeneously mixed with the starting material of the mold core. By means of such mold cores in particular local overheating is to be avoided. However, in practice this is not possible to a sufficient extent.

### SUMMARY

It is thus the object of the present invention to provide a mold core which can be heated so even temperature distribution occurs or a temperature distribution which can be specifically defined as desired results on its outer surface.

According to the invention this object is achieved by a mold core for molding and controlling the temperature of a hollow structure wherein the mold core comprises an electrically non-conducting or only slightly conducting inner area and an electrically conducting outer area as well as two electrical contacts accessible from outside for applying a voltage, wherein the thickness of the outer area is constant or is specifically varied.

In some contemplated embodiments of the invention, the outer area of the mold core can consist of a mold core base material that is enriched with electrically conducting material, such as for example conducting carbon black, graphite, short and/or long carbon fibers and/or metal powder or fibers, wherein the proportion of the electrically conducting material is constant or is specifically varied.

In some a further contemplated embodiments of the invention, a contact surface between the inner area and the outer area is formed to be smooth. “Smooth” is intended here to be interpreted as limited roughness of the contact surface.

Alternatively, in some contemplated embodiments a contact surface can be produced in the form of fins between the inner area and the outer area. In some particular contemplated embodiments of the invention, a contact surface between the inner area and the outer area is coated with silver varnish. According to further contemplated embodiments of the invention, a mold core is formed as a single-use core and can for example be rinsed out using a liquid.

The invention further relates to a method for producing a mold core, comprising molding a first body to form an inner electrically non-conducting or only slightly conducting area of the mold core, and applying molding material to the first body to form an outer electrically conducting area of the mold core and attaching two electrical contacts accessible from outside for applying a voltage, wherein the thickness of the outer area is constant or is specifically varied. The thickness can be constant in spatial or area-based terms or can be specifically varied.

A further aspect of the invention relates to the use of a mold core as described above to mold and control the temperature of a hollow structure, comprising: incorporating a material provided to produce the hollow structure into a mold, incorporating the mold core into the mold, closing the mold and producing an electrical connection for applying a voltage to the two electrical contacts of the mold core to heat the material, and after hardening of the material is complete for the hollow structure, removing the electrical connection and removing the mold core preferably through rinsing out of the hollow structure and the mold. Alternatively the mold core can also only be removed from the hollow structure once this has already been removed from the mold.

The invention is based upon the surprising recognition that through a multi-layer structure of a mold core due to the formation of an inner and an outer area and an interplay between the thickness of the outer area and the thickness of the inner area the heat production properties of a current flowing therethrough can be influenced and controlled such that at each point, and especially each point of the outer surface, of the mold core a certain quantity of heat can be achieved. The local temperature to be produced can be predefined more precisely than is possible with other known production methods or other known mold cores with comparably low resources. The mold core according to the invention also allows for the particularly efficient heating of a hollow structure as heat is produced directly on the surface of the core where it is required.

A particularly surprising effect of the invention is found in that the structure comprising two areas allows not only a control of heat distribution but also simultaneously offers thermal insulation of the inner area and thus avoids a heat sink inside the mold core. At the same time there is no unnecessary heating of areas of the mold core which are not in contact with the hollow structure, allowing for the further advantage of efficient energy use. This also offers, in comparison with the use of liquid or other movable heat carriers, the additional advantage that the mold core is particularly simple both in regard to its structure as well as in the steps necessary for its construction.

A further advantage of the current invention is that the inherit difficulties posed by movable heat carriers in connection with soluble single-use cores are avoided.

An advantage of the invention lies in that alternative heating methods which provide, for example, metal heating coils in the mold core can only be consistently reconciled with difficulty, and in particular with the dissolution of a single-use core.

In addition, the present invention allows local thermal expansions and stresses in the mold core to be avoided. As discussed in the above background discussion, it has not been previously possible to date to effectively counteract local thermal expansions, and resulting stresses therefore constitute an unresolved problem according to the prior art.

### BRIEF DESCRIPTION OF THE DRAWINGS

Further features and advantages of the invention follow from the claims and from the following description, in which example embodiments are explained using the schematic drawings in which:

FIG. 1 is a side view of a mold core according to one contemplated embodiment of the invention in a hollow structure in section; and

FIG. 2 is a side view of a mold core according to one contemplated embodiment of the invention.

### DETAILED DESCRIPTION

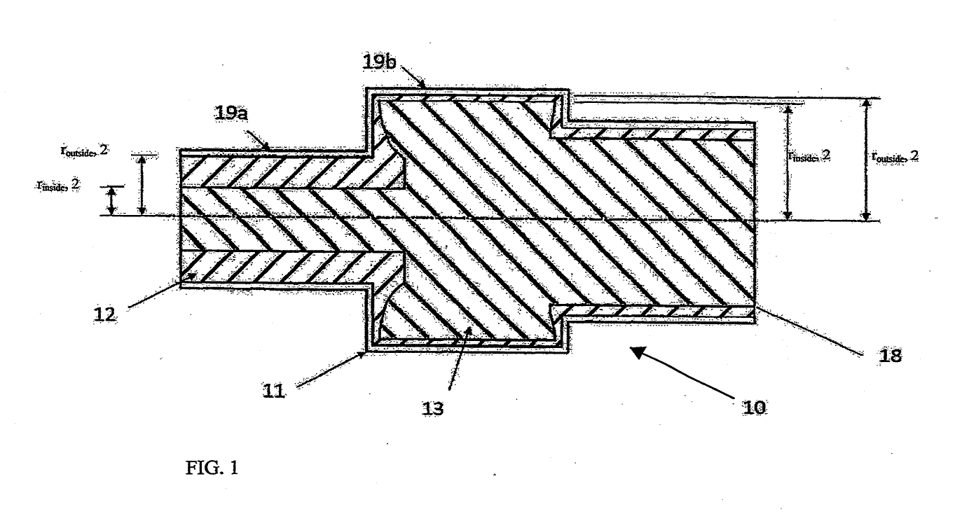

The mold core 10 shown in FIG. 1 is in area contact with a hollow structure 11 or its starting material in a mold (not shown) which is to be molded and temperature-controlled by the mold core. The mold core 10 comprises an inner area 13 and an outer area 12, wherein the outer area 12 covers the inner area 13 on all sides towards the hollow structure. The mold core 10 can be divided in the embodiment shown into sections of differing thickness of the mold core 10, that is to say cylindrical sections with different radii. The mold core 10 is thus considerably thinner in the section 19a than in the section 19b.

The outer area 12 preferably consists of molding sand which is enriched with certain electrically conducting materials in order to increase its electrical conductivity. Such a material can, for example, be conducting carbon black or graphite. Alternatively, however, short or long carbon fibers can also be used as can metal powder and/or metal fibers. The inner area 13 preferably consists of molding sand and therefore either does not conduct the electric current or, if it does conduct electric current, then it does so only to a limited extent. The inner area 13 also preferably comprises merely a low heat conductivity. It can be seen in particular from FIG. 1 that the thickness in the radial direction of the outer area 12 can vary locally in relation to the thickness of the inner area 13. Its thickness for example in the section 19a is considerably greater than in the section 19b. A greater thickness results in a lower electrical resistance which in turn leads to a lower heating effect of a current flowing through.

In some contemplated embodiments the mold core 10 can be formed as a hollow core, wherein the inner area 13 comprises at least in part a hollow chamber.

For the purpose of electrical resistance heating of the mold core, the outer area 12 is provided with contacts, to which a voltage can be applied. The contacts are not shown in FIG. 1. However, they can be arranged at any points of the outer area 12. For example the contacts can be arranged at opposing sides of the mold core. However, depending upon the requirements of the hollow structure to be hardened, a different constellation of the contacts is also conceivable.

In order to account for the different thermal conductivities of the inner area 13 and the outer area 12, the contact surface between two areas can be formed to be smooth. A smooth surface is thereby understood to be a surface of limited roughness. Alternatively, the contact surface can be formed with fins or comprise a three-dimensional structure in another way. In particular in this way the contact surface between the inner area 13 and the outer area 12 can be enlarged. In one contemplated embodiment the surface can be enlarged by fin-like contacts, for example by factor 3.4 in comparison with a smooth contact surface. Alternatively, in some contemplated embodiments the contact surface can be provided with a silver varnish coating. This serves in particular as an extensive thermal insulation of the inner area 13 from the outer area 12 in order to be able to adjust the desired heat distribution more precisely.

The form of the mold core according to the invention can thus be realized as desired both in longitudinal and in transverse directions.

In one contemplated example embodiment described below, a hollow structure is produced which comprises a hollow space in the form of two coaxially arranged hollow cylinders with differing radii. Subject to the secondary condition that the mold core corresponding to the hollow space is to produce over its whole outer surface an even heat development, it is the intention to determine with given outer dimensions of the mold core the necessary cross-sectional area of the inner area on a certain section. The outer area 12 of the mold core in section 19a may have an inner radius r_{inside,1} and an outer radius r_{outside,1} and in section 19b an outer radius r_{outside,2}. The question is then posed as to how large the inner radius r_{inside,2} in section 19b must be in order to provide the same heat output in an outward sense. In this connection consider:

The circumference of a cylinder is given as

U=2π·r

With increasing circumference U the heat output to be provided necessary to bring about constant temperature control increases linearly. This heat output is, in addition, proportional to the electrical resistance R. Furthermore the cross-sectional area of a cylindrical inner area 13 is proportional.

A_{inside}=π·r²_{inside},

The total cross-sectional area A of a cylinder i amounts to

Aᵢ=π·r²_{outside}.

The cross-sectional area A_{outside,i} of the outer area 12 without the inner area 13 for a cylinder i can thus be indicated as

A_{outside,i}=A−A_{inside}.

The electrical resistance of a cylinder i is inversely proportional to the cross-sectional area A_{outside,i} of its outer area 12. For two cylinders 1 and 2 this equation can be given as

$$\frac{{A}_{outside , 1}}{{A}_{outside , 2}} = \frac{{R}_{2}}{{R}_{1}} .$$

Furthermore the following applies:

$$\frac{{R}_{2}}{{R}_{1}} = \frac{{U}_{2}}{{U}_{1}} ⇒ {A}_{outside , 2} = \frac{{U}_{1}}{{U}_{2}} \cdot {A}_{outside , 1} .$$

The desired radius r_{inside,2} can be calculated from this equation from

$${A}_{outside , 2} = π \cdot {r}_{outside , 2}^{2} - π \cdot {r}_{inside , 2}^{2} ; \frac{{U}_{1}}{{U}_{2}} \cdot {A}_{outside , 1} = \frac{2 π \cdot {r}_{outside , 1}}{2 π \cdot {r}_{outside , 2}} \cdot ( π \cdot {r}_{outside , 1}^{2} - π \cdot {r}_{inside , 1}^{2} ) \\ ⇒ {r}_{inside , 2} = \sqrt{{r}_{outside , 2}^{2} - \frac{{r}_{outside , 1}}{{r}_{outside , 2}} \cdot ( {r}_{outside , 1}^{2} - {r}_{inside , 1}^{2} )}$$

Therefore, with a fixed radius r_{outside,1} on a first section 19a of the mold core 10 and fixed radius r_{outside,2} on a second section 19b of the mold core 10 the outer radius (=r_{inside,1}) of the inner area 13 can be selected on the first section 19a so that a predetermined heating is produced on the first section 19a, and the outer radius (=r_{inside,2}) of the inner area 13 on the second section 19b is selected depending on r_{inside,1}, r_{outside,1} and r_{outside,2} such that the same heating is produced on the second section 19b as on the first section 19a. The cross-sectional area of the inner and outer area on the section 19b is thus known.

According to a contemplated alternative embodiment with square, rectangular or any cross-sectional forms of the mold core, the above equations can be similarly used, wherein merely the correct functions are to be used to calculate the respective cross-sectional area and circumference.

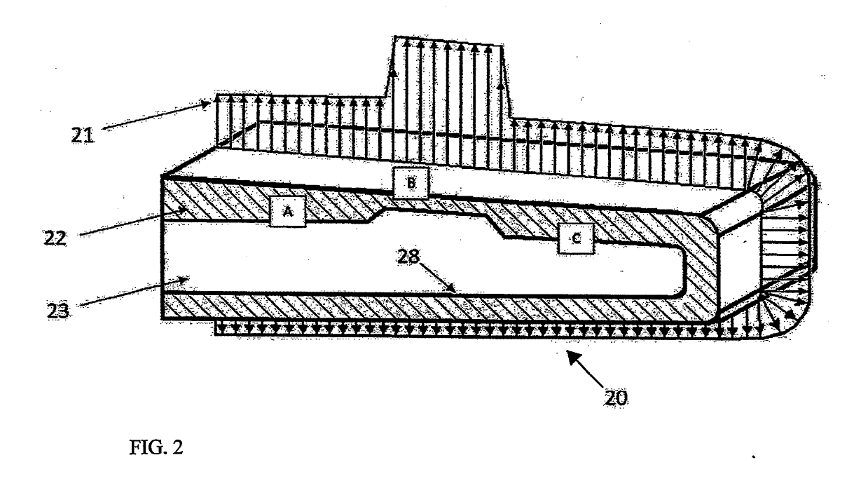

FIG. 2 depicts a further contemplated embodiment of the invention wherein a mold core 20 is shown with an inner area 23 and an outer area 22. The areas 22 and 23 have a cross-section in the longitudinal direction of the mold core 20 which continually changes over several sections, for example in the section marked A. Transversely to the longitudinal direction of the mold core the areas 22 and 23 have a rectangular cross-section. FIG. 2 further depicts a temperature profile 21 on the surface of the outer area 22. This shows for example that in section A, a very much lower temperature prevails than in section B. This difference is due to the fact that the thickness of the outer area 22 in section B is very much smaller than in section A. The outer area 22 thereby has in section B a greater electrical resistance than in section A, whereby this leads, when an electric current flows therethrough, to a higher heating effect and thus to increased temperature. The temperature profile 21 further exhibits a slight increase of temperature in section A of the outer area 22 in the direction of section B. This results from the tapering thickness of the outer area 22 in section A in the direction of section B and is based upon an associated continuous reduction in the electrical resistance of the outer area 22. The composition of the areas 22 and 23 of FIG. 2 and the remaining properties of the mold core 20 shown can, moreover, comprise the same properties as the mold core 10 of FIG. 1.

The above approaches for influencing local heating within a mold core, which—as shown—are based in particular upon an adaptation of the area thicknesses, can be advantageously combined with an enrichment of additional materials in the outer area 12 that differs in spatial or area-related terms. In particular, a particularly great local variation of the area thicknesses according to the above provisions can be weakened in that, through the addition of electrically conducting additional materials in the area in question, the electric conduction properties are adapted so that only a lower variation in area thicknesses is necessary. When selecting such additional materials it is not only electrical conductivity but also heat conductivity that is also to be considered, whereby for example, in case of an increase in the electrical resistance, an improvement in the heat conductivity is to be sought. This requirement is fulfilled, for example, by conducting carbon black, graphite, or carbon fibers, whereby the latter can be present as short or long fibers. Alternatively or additionally metal powder and/or metal fibers can also be used. Finally, combinations of such materials can also be used. Graphite is noted as one such preferable material as it not only has a high heat conductivity and electrical conductivity but also a high temperature resistance as well as a high temperature change resistance. The latter favours an acceleration of heating and cooling phases during the hardening processes of a fiber composite structure. In addition, graphite has a high resistance to oxidation and is particularly resistant to certain chemicals. Graphite can also be produced with high purity levels and is easy to process, environmentally friendly, and is safe with regard to health during processing.

The invention can be used to produce hollow structures, for example fiber composite structures, in pressure casting methods, or in the field of injection molding processes. In general the invention constitutes an improvement in the production of complex hollow structures, in which it is necessary or advantageous to control temperature.

In order to produce a mold core according to the above-described embodiments, essentially two steps are necessary. First, the inner electrically non-conducting or only slightly conducting area is formed, wherein, for example, a pressure process is used. Typically the inner area thereby consists of molding sand. Second, the outer electrically conducting area 12 is applied to the inner area 13 so that the outer area 12 covers the inner area 13. Furthermore, contacts are supplied on the outer area 12 in order to allow the application of a voltage to the outer area 12. The thicknesses of the two areas are thereby measured to suit the respective requirements of the application, in particular in consideration of the above indications relating to the invention.

In order to use the mold core according to the invention to mold and control the temperature of a hollow structure 11 to be hardened, according to one contemplated embodiment, initially a substance provided to produce the hollow structure is incorporated into a mold. Subsequently the mold core is embedded in the mold so that it forms with it a cavity. Methods known to those skilled in the art can be used in this connection. Subsequently a voltage is applied to the two contacts of the mold core 12 in order to heat the substance. After complete hardening of the hollow structure 11, the electrical connection is removed and the mold core 10—if it is a single-use core—is rinsed out of the hollow structure and the mold or only after removal of the hollow structure from the mold, or—if the core is a reusable core—is removed from the hollow structure 11 and the mold in a different way to allow for later use.

In the embodiments shown and described above, a mold core is described which constitutes a new and particularly efficient way of achieving a certain distribution for hardening a surrounding fiber composite structure. Besides the aforementioned advantages of the invention, reference is made to a particularly simple, rapid and cost-effective core production which can additionally be advantageously automated. Due to the simple structure, low costs are to be expected in the construction of such a mold core, in particular as the main constituent parts of a corresponding installation merely comprise a power generator and a power control. The aforementioned environmental friendliness of the mold core according to the invention is further based on the fact that no medium for supplying heat to the core is necessary. There is thus no waste product, for which disposal could be expensive.

The features of the invention disclosed in the present description, in the drawings and in the claims can be used both individually and in any combinations for the realization of the invention in its different embodiments. This invention has been described with reference to several preferred embodiments. Many modifications and alterations will occur to others upon reading and understanding the preceding specifications. It is intended that the invention be construed as including all such alterations and modifications and so far as they come within the scope of the appended claims or the equivalence of these claims.

1. A mold core for molding and controlling the temperature of a hollow structure, comprising:
an inner area, said inner area being at least one of electrically non-conducting and only slightly electrically conducting;
an electrically conducting outer area;
a first electrical contact and a second electrical contact, said first electrical contact and said second electrical contact being accessible from outside said mold core for applying a voltage; and
said outer area of said mold core having a determined thickness at positions along said outer area.

2. The mold core of claim 1 wherein said thickness of said outer area is constant.

3. The mold core of claim 1 wherein said thickness of said outer area is specifically varied.

4. The mold core of claim 1 further comprising:
said outer area includes a mold core base material, said mold core base material being enriched with an electrically conducting material; and
said electrically conducting material being present in a determined proportion.

5. The mold core of claim 4, wherein the proportion of said electrically conducting material is constant.

6. The mold core of claim 4, wherein the proportion of said electrically conducting material is specifically varied.

7. The mold core of claim 4 wherein said electrically conducting material is at least one of conducting carbon black, graphite, short carbon fibers, long carbon fibers, metal powder, and metal fibers.

8. The mold core of claim 1 further comprising a contact surface between said inner area and said outer area, said contact surface being formed to be smooth.

9. The mold core of claim 1 further comprising a contact surface between said inner area and said outer area, said contact surface being formed with fins.

10. The mold core of claim 1 further comprising a contact surface between said inner area and said outer area, said contact surface being coated with silver varnish.

11. The mold core of claim 1 wherein said mold core is formed as a single-use core.

12. The mold core of claim 1 wherein said mold core can be rinsed out using a liquid.

13. A method for producing a mold core, comprising:
molding a first body to form an inner area of said mold core, said inner area being at least one of electrically non-conducting and only slightly electrically conducting;
applying mold material to said first body to form an outer electrically conducting area of said mold core; and
attaching a first electrical contact and a second electrical contact to said mold core such that said first and second electrical contacts are accessible from outside said mold core for applying a voltage.

14. The method for producing a mold core of claim 13 further comprising providing a thickness of said outer area that is constant.

15. The method for producing a mold core of claim 13 further comprising providing a thickness of said outer area that is specifically varied.

16. The method for producing a mold core of claim 13 further comprising;
providing a mold core base material for said outer area, said mold core base material being enriched with an electrically conducting material; and
providing said electrically conducting material in a determined proportion.

17. The method for producing a mold core of claim 16, wherein the proportion of said electrically conducting material is constant.

18. The method for producing a mold core of claim 16, wherein the proportion of said electrically conducting material is specifically varied.

19. The method for producing a mold core of claim 16 wherein said electrically conducting material is at least one of conducting carbon black, graphite, short carbon fibers, long carbon fibers, metal powder, and metal fibers.

20. The method for producing a mold core of claim 13 further comprising providing a contact surface between said inner area and said outer area, said contact surface being formed to be smooth.

21. The method for producing a mold core of claim 13 further comprising providing a contact surface between said inner area and said outer area being formed with fins.

22. The method for producing a mold core of claim 13 further comprising providing a contact surface between said outer area and said inner area, said contact surface being coated with silver varnish.

23. The method for producing a mold core of claim 13 further comprising applying said outer area to said inner area while heating under pressure or by heat effect.

24. A method for using the mold core of claim 1 for molding and controlling the temperature of a hollow structure, said method comprising:
incorporating a material provided for producing said hollow structure into a mold;
incorporating said mold core into said mold;
closing said mold and producing an electrical connection for applying a voltage to said first electrical contact and said second electrical contact of said mold core for heating said material; and
allowing hardening of said material for said hollow structure, and after hardening of said material is complete, removing said electrical connection and rinsing out said mold core from said hollow structure and said mold.
